(19) United States
(12) Patent Application Publication
(10) Pub. No.: US 2004/0119346 A1
(43) Pub. Date: Jun. 24, 2004

(54) Gas-cooled, rotating electrical, in particular a turbogenerator,and method of operating such a machine

(76) Inventors: Armin Schleussinger, Windisch (CH); Juergen Bear, Magenwil (CH); Christoph Hirsch, Eching (DE)

Correspondence Address: ADAM J. CERMAK, LAW OFFICE OF ADAM J. CERMAK, P.O. BOX 7518, ALEXANDRIA, VA, 22307-7518, US

(21) Appl. No.: 10/431,591

(22) Filed: May 8, 2003

(30) Foreign Application Priority Data
May 8, 2002 (CH) 2002 0783/02

(51) Int. Cl. H02K 9/26; H02K 9/00

(52) U.S. Cl. 310/58; 310/56

(57) ABSTRACT

A gas-cooled, rotating electrical machine, in particular a turbogenerator (1), has a rotatably mounted rotor (4) and a stator (3) concentrically surrounding the rotor (4), the rotor (4) and the stator (3) being accommodated in a housing (2), at least one axial flow fan (5) being arranged at the end face on the rotor (4) in order to cool the machine, this axial flow fan (5) drawing in a gaseous cooling medium from a coaxial suction space (1) and forcing it into a pressure space (11).

In such a machine, an improvement in the efficiency is achieved by an adjustable guide device (19) being provided in the region of the suction space (10) on one side in order to vary the characteristic curve of the axial flow fan (5), by means of which guide device (19), with regard to the direction of rotation of the axial flow fan (5), a co-swirl or a counter-swirl or a mixture of both types of swirl is optionally applied to the cooling medium flowing into the suction space (10).

### FIELD OF THE INVENTION

The present invention relates to the field of electrical machines. It relates to a gas-cooled, rotating electrical machine, in particular a turbogenerator, according to the preamble of claim 1. It also relates to a method of operating such a machine.

### DISCUSSION OF BACKGROUND

Gas-cooled turbogenerators, as are described, for example, in U.S. Pat. No. 5,557,153 or U.S. Pat. No. 6,124,653, contain axial flow fans for dissipating their electrical and mechanical heat losses, these axial flow fans in most cases being arranged at the end face on the generator shaft. The basic construction of such a gas-cooled turbogenerator is reproduced in longitudinal section in FIG. 1. The known turbogenerator 1, resting on a foundation 25, is accommodated in a housing 2. It comprises a rotor 4 which is mounted in bearings 14 such as to be rotatable about a horizontal machine axis and is concentrically surrounded by a stator 3. The rotor 4 has an axial flow fan 5 on the rotor shaft at each end face. The gaseous cooling medium forced through the generator 1 by means of the axial flow fans 5 is cooled down to the specified/agreed standard coolant temperature in coolers 6 arranged below the machine axis between stator 3 and foundation 25. The direction of flow of the cooling medium in the coolers 6 is identified by first arrows (cooling medium flow 8). The inflow of the cooling medium to the axial flow fans 5 is shown by second arrows (cooling medium flow 7), the cooling medium being fetched from an intake or cold-gas space 15. By agreement with the customer or in accordance with the power plant configuration, the cold-gas space 15 may be arranged on any desired side of the generator (clockwise at 3, 6, 9 or 12 o'clock; in the present case it is at the 6 o'clock position; see also FIG. 4).

FIG. 2 shows the immediate surroundings of one (right-hand) axial flow fan 5 from FIG. 1 in an enlarged detail, having an inner casing 9, a suction space 10 and a pressure space 11. The inner casing 9 separates the suction space 10 from the pressure space 11. The axial flow fan 5 draws in the gaseous cooling medium (e.g. air) in the suction space 10 and forces it into the pressure space 11. In order to achieve as small a backflow as possible, a tip cover 12 which projects into the pressure space 11 is arranged on the inner casing 9 around the axial flow fan 5.

FIG. 3 (in a detail enlarged to an even greater extent) merely shows a slightly different embodiment of the inner casing 9, at which the tip cover 13 of the axial flow fan 5 does not project into the pressure space but into the suction space 10.

Finally, FIG. 4 reproduces the view in the direction of the machine axis into the fan suction space 10, opened by the omission of the fan outer casing 24 (FIG. 3), where, at the end face, the axial flow fan 5, with its direction of rotation 18, and the cooling-medium inflow shown by arrows (inflow 16, 17) can be seen. FIG. 4 illustrates that the axial flow fan 5 is subjected to flow by a co-swirl (in the direction of rotation 18 of the fan) at the inflow 16 and by a counter-swirl (against the direction of flow 18 of the fan) at the inflow 17. This leads to nonuniform pressure generation over the circumference of the axial flow fan 5 and to medium delivery, which ultimately ends in a reduced output of the axial flow fan 5 and thus of the cooling overall.

Since turbogenerators, on account of the power output adapted to the turbine, are mainly operated at constant load, the axial cooling-circuit fans 5, depending on design and production, work within a more or less very good efficiency range. In larger turbogenerators with air cooling, the fan losses may reach a loss proportion of up to 50% and may easily extend above this. This of course applies to the design point/nominal working point of the generator. If a turbogenerator 1 is run in part-load operation for prolonged periods due to load fluctuations or cooler failure, the generator efficiency noticeably decreases due to the fan losses, which remain constant. Without shutting down the generator and rearranging the staggered configuration of the fan blades—if the latter can be adjusted at all—it is at present not possible to reduce the fan losses and thus increase the generator efficiency, which would lead to a fuel reduction. A waste of energy caused by the fan losses therefore turns out to be a serious disadvantage for the known turbogenerators.

### SUMMARY OF THE INVENTION

The object of the invention is therefore to provide a gas-cooled, rotating electrical machine, in particular a turbogenerator, which avoids the disadvantages of the known machines and is distinguished in particular by markedly reduced fan losses.

This object is achieved by the features of claim 1 in their entirety. The essence of the invention consists in providing an adjustable guide device in the region of the suction space on one side (clockwise at 3, 6, 9 or 12 o'clock), by means of which guide device, with regard to the direction of rotation of the axial flow fan, a co-swirl or a counter-swirl or a mixture of both types of swirl is optionally applied to the cooling medium flowing into the suction space. As a result, the characteristic curve of the axial flow fan can be varied in such a way that it can be optimally adapted to the different operating conditions with regard to the efficiency. The lateral arrangement of the guide device ensures that the guide device—unlike in the case of a variant arranged coaxially to the fan on the same plane—can be favorably integrated from the design and production point of view in the housing of the generator in such a way that the pre-swirl for the axial flow fan can be changed from co-swirl to counter-swirl in a simple manner. A coaxial arrangement of the generator shaft, on the other hand, is not possible for technical reasons related to vibration of the generator shaft—on account of the requisite extension of the generator shaft.

The suction space is preferably connected to a cold-gas space which is arranged on one side outside the machine and from which the re-cooled cooling medium flows into the suction space, and the guide device is arranged between the cold-gas space and the suction space. In this case, the cold-gas space may also be integrated in the generator housing.

A preferred development of the guide device is characterized in that the guide device comprises a plurality of parallel, adjustable guide blades, and in that the guide blades of the guide device are arranged one behind the other in a line running transversely to the inflow direction of the cooling medium into the suction space and are adjustable in their angular position relative to the inflow direction. In this case, the guide blades are preferably jointly adjustable.

In particular, the guide blades may be manually and/or automatically adjustable from outside the housing by means of a mechanical actuating device, in particular a linkage. A servomotor may also be provided for adjusting the guide blades.

The guide blades preferably all have the same blade shape, to be precise either a straight blade shape or a droplet profile.

Further embodiments follow from the dependant claims.

### BRIEF DESCRIPTION OF THE FIGURES

The invention is to be explained in more detail below with reference to exemplary embodiments in connection with the drawing, wherein:

FIG. 1 shows a simplified longitudinal section of a gas-cooled turbogenerator with two end axial flow fans for the operation of the cooling circuit from the prior art;

FIG. 2 shows an enlarged detail from FIG. 1, which shows one (right-hand) axial flow fan and in which at the same time a guide device for the axial flow fan according to a preferred exemplary embodiment is depicted;

FIG. 3 shows an enlarged representation of an axial flow fan of a turbogenerator from the prior art with a modified tip cover of the axial flow fan compared with FIG. 1;

FIG. 4 shows the view in the direction of the machine axis into the fan suction space, opened by the omission of the fan outer casing, of the machine from FIG. 3;

FIGS. 5-7 show, in a representation comparable with FIG. 4, a turbogenerator with a guide device according to the invention in three different positions which correspond to a different pre-swirl of the cooling medium flow, namely a neutral position (FIG. 5), maximum co-swirl (FIG. 6) and maximum counter-swirl (FIG. 7); and

FIG. 8 shows, in a representation comparable with FIG. 4, a turbogenerator with a guide device according to the invention having different types of exemplary guide blades.

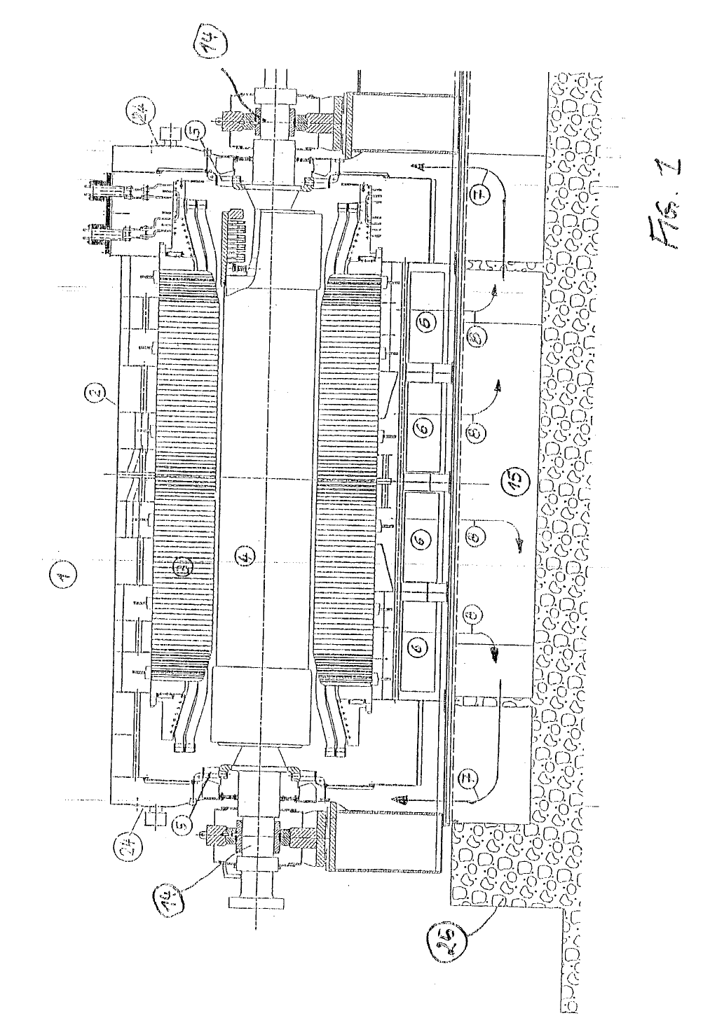

### WAYS OF IMPLEMENTING THE INVENTION

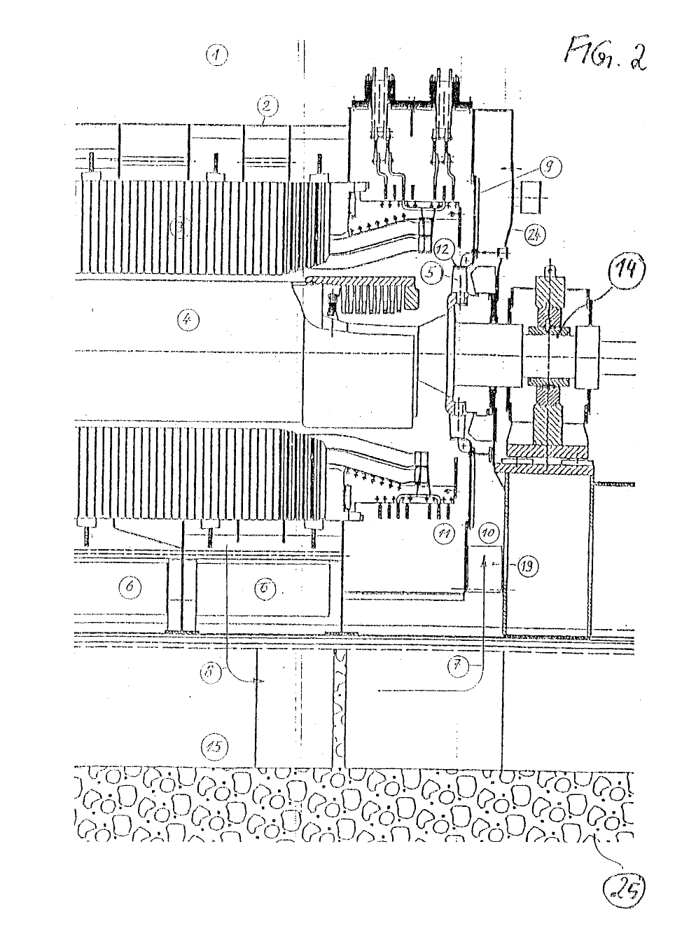

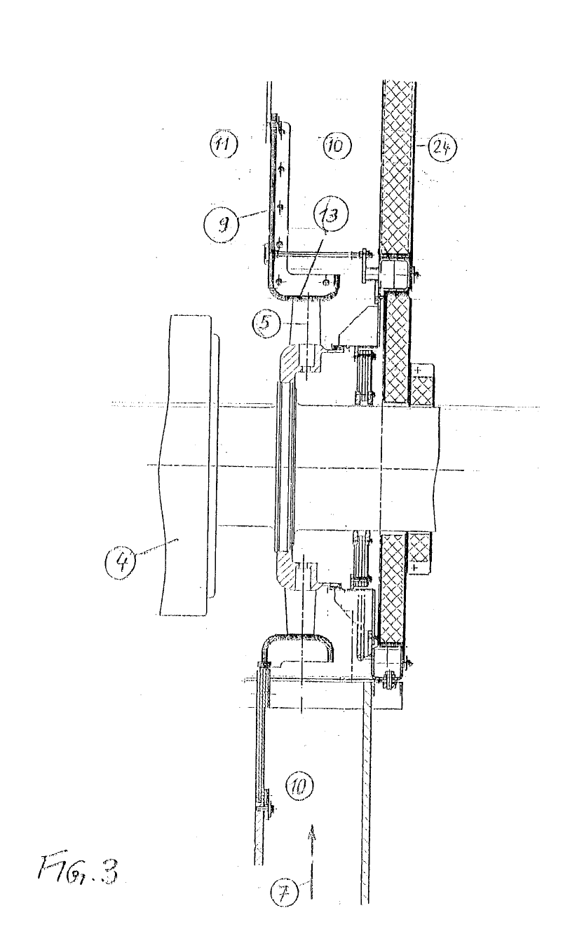

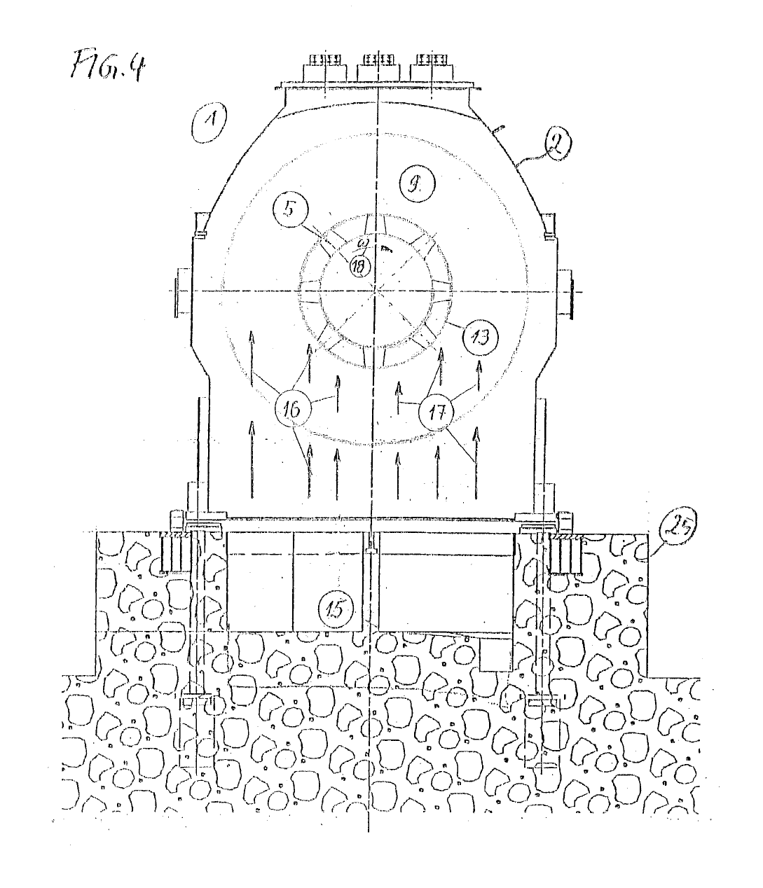

A preferred exemplary embodiment of a machine according to the invention with a guide device for producing a certain pre-swirl is reproduced in FIG. 2 and FIGS. 5-7 from different directions of view. The guide device 19, which comprises a plurality of guide blades 22, is not arranged in an annular manner directly upstream of and downstream of the axial flow fan 5 but comes to lie on one side (at 3, 6, 9 or 12 o'clock; in the 6 o'clock position in the example shown) in the suction space 10 of the axial flow fan 5 or in the cold-gas space (intake space) 15 underneath, the latter only if the intake is effected from the 6 o'clock direction. The great advantage consists in the fact that the guide device (swirl-generating device) 19 is arranged such as to be rolled out (along a straight line) and the guide blades 22 can be adjusted with a linkage via or with gears from outside the housing 2.

The swirl change, which may be effected with an angular adjustment of the guide blades 22 of the guide device 19 from a co-swirl (to reduce the output in the event of a cooler failure, for example) up to a counter-swirl (to increase the output in the event of continuous overload, for example), may be effected manually or via a servomotor as a function of temperature or output.

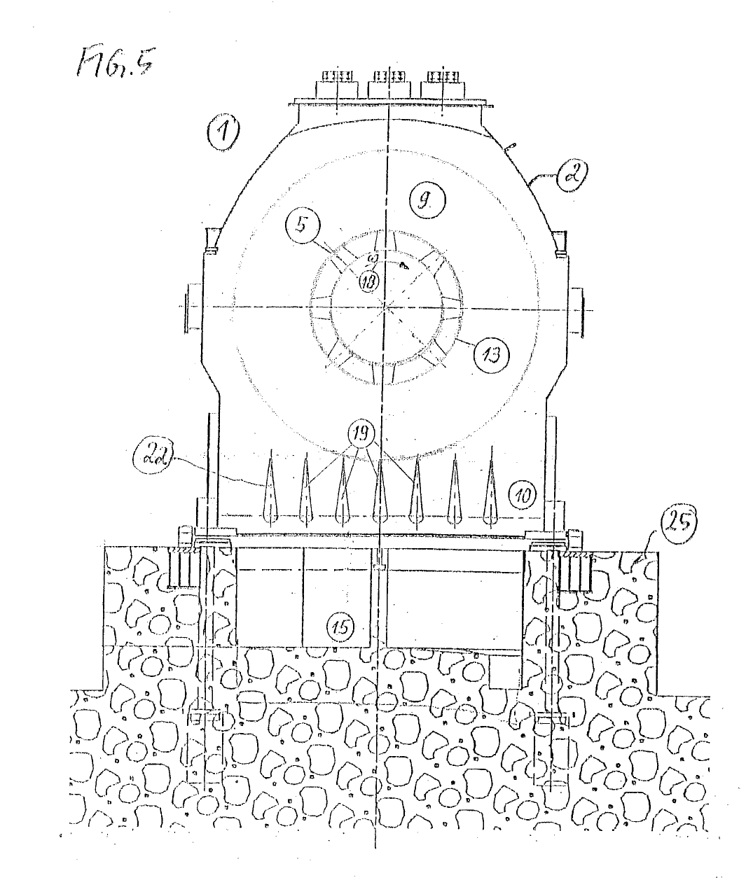

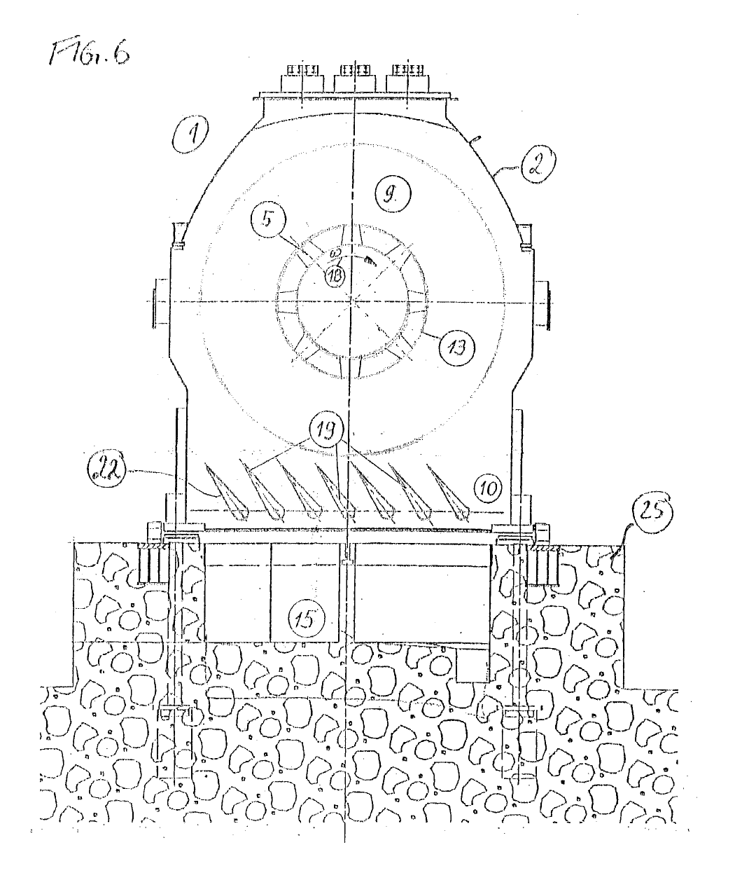

FIG. 5 shows the guide device 19 in the suction space 10 of the axial flow fan 5 in a (neutral, center, straight) setting, so that the axial flow fan 5 is subjected to flow with a counter-swirl and with a co-swirl. This case corresponds essentially to the configuration without a guide device. The disadvantages have therefore already been explained above. This case is to be classified as nominal working point/design point (current state without these guide blades). FIG. 6 shows the guide blades 22 of the guide device 19 in a position which, in the suction space 10 for the axial flow fan 5, generates a co-swirl over the entire circumference, so that the characteristic curve of the axial flow fan 5 runs in a flatter manner, and the working point lies deeper, which, for a reduction in output, with the fan efficiency remaining approximately constant, is used for the case of a generator operation with partial load or cooler failure.

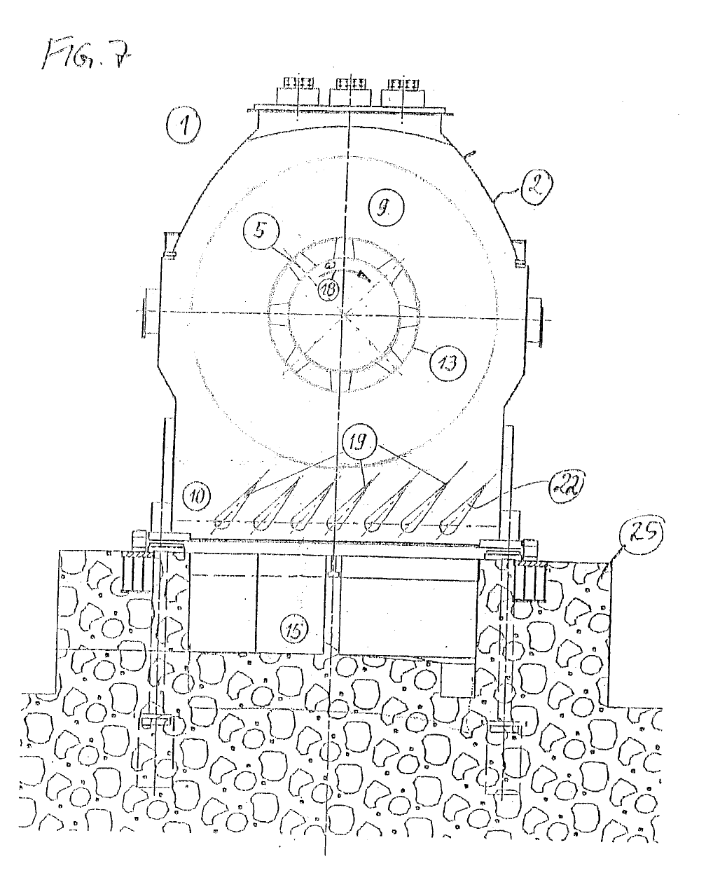

FIG. 7 shows the guide blades 22 of the guide device 19 in a position which, in the suction space 10 for the axial flow fan 10, generates a counter-swirl to the direction of rotation 18 of the axial flow fan 5 over the entire circumference, so that the characteristic curve of the fan is raised, and the working point lies higher, which, for an increase in output, is used for the case of a generator operation with constant overload or continuous increase in output.

The novelty of this idea is that the guide device 19 for the delivery medium/cooling medium is not arranged coaxially to the axial flow fan 5 on the same plane, but is favorably integrated from the design and production point of view in the housing 2 of the generator 1 in such a way that the pre-swirl for the axial flow fan 5 can be changed from co-swirl to counter-swirl in a simple manner. In this case, it may be expedient that the guide blades can be fixed at certain angles or can be locked.

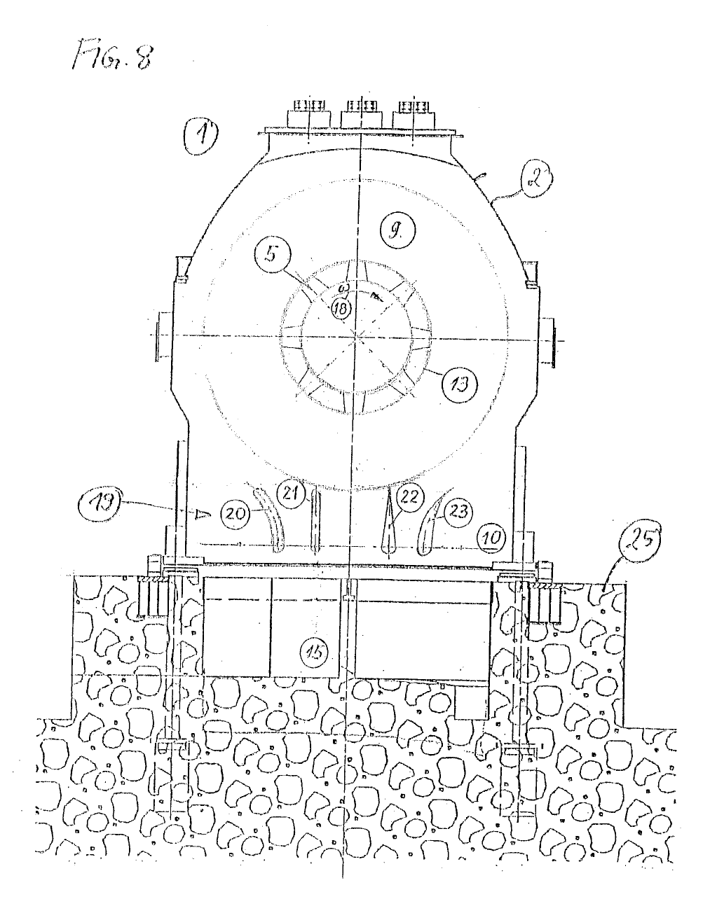

FIG. 8, with reference to individual guide blades, shows further possible embodiments 20, 21, 22, 23 of the guide blades of the guide device 19. The guide blades may be designed as:

sheet-metal profile, curved (guide blade 20)

sheet-metal profile, straight (guide blade 21)

droplet profile, straight (guide blade 22, see above)

droplet profile, curved (guide blade 23)

On the whole, the invention is distinguished by the following characteristic features:

Arrangement of a guide device with guide plates/blades in turbogenerator housings for generating a pre-swirl for the axial flow fan in order to influence the fan characteristic curve p=f[V] and thus adapt the power input of the fan to the generator output—to the requisite cooling conditions.

The guide blades are made of a material adapted to the requirements.

The guide blades preferably consist of straight or curved plates or droplet profiles.

The guide blades are rotatably mounted and can be adjusted at an angle.

The adjustment of the guide blade angles may be effected by means of a mechanical device (linkage) manually or automatically, e.g. electronically, via a servomotor or the like.

The guide blades can be locked at particular angles.

The angular adjustment of the guide blades can be applied in an especially advantageous manner to axial flow fans having fixed moving blades (welded or firmly screwed arrangement).

### LIST OF DESIGNATIONS

1 Turbogenerator

2 Housing

3 Stator

4 Rotor

5 Axial flow fan

6 Cooler

7, 8 Cooling medium flow

9 Inner casing

10 Suction space

11 Pressure space

12, 13 Tip cover

14 Bearing

15 Cold-gas space (intake space)

16 Inflow (co-swirl)

17 Inflow (counter-swirl)

18 Direction of rotation

19 Guide device (swirl-generating device)

20 . . . 23 Guide blade

24 Outer casing

25 Foundation

What is claimed is:

1. A gas-cooled, rotating electrical machine, in particular a turbogenerator (1), having a rotatably mounted rotor (4) and a stator (3) concentrically surrounding the rotor (4), the rotor (4) and the stator (3) being accommodated in a housing (2), at least one axial flow fan (5) being arranged at the end face on the rotor (4) in order to cool the machine, this axial flow fan (5) drawing in a gaseous cooling medium from a coaxial suction space (1) and forcing it into a pressure space (11), characterized in that an adjustable guide device (19; 20 . . . 23) is provided in the region of the suction space (10) on one side in order to vary the characteristic curve of the axial flow fan (5), by means of which guide device (19; 20 . . . 23), with regard to the direction of rotation (18) of the axial flow fan (5), a co-swirl or a counter-swirl or a mixture of both types of swirl is optionally applied to the cooling medium flowing into the suction space (10).

2. The machine as claimed in claim 1, characterized in that the suction space (10) is connected to a cold-gas space (15) which is arranged on one side outside the machine and from which the re-cooled cooling medium flows into the suction space (10), and in that the guide device (19; 20 . . . 23) is arranged between the cold-gas space (15) and the suction space (10).

3. The machine as claimed in either of claims 1 and 2, characterized in that the guide device (19; 20 . . . 23) comprises a plurality of parallel, adjustable guide blades (20 . . . 23).

4. The machine as claimed in claim 3, characterized in that the guide blades (20 . . . 23) of the guide device (19) are arranged one behind the other in a line running transversely to the inflow direction of the cooling medium into the suction space (10) and are adjustable in their angular position relative to the inflow direction.

5. The machine as claimed in either of claims 3 and 4, characterized in that the guide blades (20 . . . 23) are jointly adjustable.

6. The machine as claimed in one of claims 3 to 5, characterized in that the guide blades (20 . . . 23) are manually and/or automatically adjustable from outside the housing (2) by means of a mechanical actuating device, in particular a linkage.

7. The machine as claimed in one of claims 3 to 6, characterized in that a servomotor is provided for adjusting the guide blades (20 . . . 23).

8. The machine as claimed in one of claims 3 to 7, characterized in that the guide blades (20 . . . 23) all have the same blade shape.

9. The machine as claimed in one of claims 3 to 8, characterized in that the guide blades (21, 22) have a straight blade shape.

10. The machine as claimed in claim 9, characterized in that the guide blades (2) are each made of sheet metal.

11. The machine as claimed in claim 9, characterized in that the guide blades (22) have a droplet profile.

12. The machine as claimed in one of claims 3 to 8, characterized in that the guide blades (20, 23) have a curved blade shape.

13. The machine as claimed in claim 12, characterized in that the guide blades (20) are each made of sheet metal.

14. The machine as claimed in claim 12, characterized in that the guide blades (23) have a droplet profile.

15. The machine as claimed in one of claims 1 to 14, characterized in that the axial flow fan (5) is provided with fixed moving blades.

16. A method of operating a machine as claimed in one of claims 1 to 15, characterized in that the adjustment of the guide device (19) or of the guide blades (20 . . . 23) is effected as a function of temperature and/or output.
